(19) United States
(12) Patent Application Publication
(10) Pub. No.: US 2023/0091599 A1
(43) Pub. Date: Mar. 23, 2023

(54) Portable Audio Content Device and Method of Use Thereof

(71) Applicant: Maria Schuman, Caldwell, ID (US)

(72) Inventor: Maria Schuman, Caldwell, ID (US)

(21) Appl. No.: 17/867,737

(22) Filed: Jul. 19, 2022

Related U.S. Application Data
(60) Provisional application No. 63/245,880, filed on Sep. 19, 2021.

(51) Int. Cl. H04N 21/41; H04N 21/218; H04N 21/414

(52) U.S. Cl. CPC H04N 21/4126; H04N 21/21825; H04N 21/41422

(57) ABSTRACT

The present invention relates to a portable audio content device such as a USB flash drive with pre-loaded audio content. The device is compatible with the USB ports of music/audio systems of vehicles and enables playing audio without a Wi-Fi, Bluetooth, satellite, or internet connection. The device has a flash memory for loading audio content and a USB interface for inserting into the USB port of a music system. The device has a housing for accommodating flash memory, a memory controller, an integrated silicon package and a connector. The exterior surface of the housing displays an art cover or other images related to content stored in the drive. The drive provides a plurality of controls on display of the vehicle for controlling playing of the audio content. Further, the device can be formatted to load new audio content and/or delete existing audio content.

### CROSS-REFERENCE TO RELATED APPLICATION

The present application claims priority to, and the benefit of, U.S. Provisional Application No. 63/245,880, which was filed on Sep. 19, 2021, and is incorporated herein by reference in its entirety.

### FIELD OF THE INVENTION

The present invention relates generally to the field of portable, digital-type storage devices. More specifically, the present invention relates to a multipurpose USB compatible thumb drive that has a number of pre-loaded music albums. The thumb drive is configured to be easily inserted into a USB port of a vehicle for playing the pre-loaded music without the necessity of being connected to a network such as Wi-Fi, Bluetooth, or other connection such as iPhone. The drive is configured to be formatted using a computing system and provides a plurality of controls for playing, pausing, replaying, shuffling, playback speed, and moving forward and backward through the list of songs or albums stored in the thumb drive. Accordingly, the present disclosure makes specific reference thereto. Nonetheless, it is to be appreciated that aspects of the present invention are also equally applicable to other like applications, devices and methods of manufacture.

### BACKGROUND

By way of background, listening to music in a vehicle while driving is common practice for drivers and other passengers and historically, major audio technologies including, but not limited to, AM radio, FM radio, stereo, compact disks, cassettes, and other formats have migrated from the domestic market to the automotive market. One common method of listening to music in a vehicle is radio. However, using radio for listening to music while driving is a daunting task. A driver may have to scroll multiple channels to select a specific channel which is considered unsafe as this may distract drivers from driving. Further, a radio station generally plays the same music repeatedly, and radio stations may only play artists from a specific label and a person cannot choose a specific album or artist or move to different genres on demand.

Earlier models of vehicles have integrated compact disc players or other equipment for playing music. For listening to music using such a system, people are required to carry a large collection of compact disks (CDs) in their vehicles which occupies storage space. Also, a driver needs to repeatedly insert and remove CDs to keep listening to music based on their preferences. Again, changing of CDs is considered unsafe and further, newer models of vehicles often do not have CD players and thus people desire a safer and easier way of listening to preferred music in their vehicles.

Another option is for people often having paid subscriptions for radio services or music providers for their vehicles, such as Sirius®. However, such subscriptions use an active and strong internet or satellite connection for streaming music which may not always be available and accessible such as when the vehicle is in a tunnel, or other enclosed area where the satellite signal is not available. Further, such paid subscriptions are expensive, may lock the user into a long-term contract and therefore, people desire a cost-effective method for listening to music in vehicles that does not depend on an internet or satellite connection.

Another common way of listening to music in vehicles is by connecting a smartphone to the vehicle via Bluetooth and then stream music on the smartphone and relay the music to the speakers of the vehicle. However, this can become a safety concern for the drivers as the drivers may get distracted while using their smartphone. Further, Bluetooth connection is often difficult to establish between the smartphone and the vehicle which is time consuming and frustrating. In addition, if connecting to a rental car, one may inadvertently leave personal details on the rental vehicle and contact information which is undesirable.

Therefore, there exists a long-felt need in the art for a simple and non-complicated device that can be safely and effectively used for playing music in vehicles. There is also a long-felt need in the art for a music device that does not require Wi-Fi, Bluetooth, satellite or internet connection for playing music and using the device. Additionally, there is a long-felt need in the art for a device that can be easily used with any vehicle for playing music. Moreover, there is a long-felt need in the art for a device that does not require a user to connect their smartphone to a radio for listening to music in their vehicles. Further, there is a long-felt need in the art for a music device that provides music in a vehicle in a cost-effective, convenient, easy-to-use, and safe manner. Finally, there is a long-felt need in the art for a music device that can be easily used with all types of vehicles, such as automobiles, ATVs, UTVs, trucks, recreational vehicles, boats, and other passenger areas, and allows people to play music without hassle, compromising safety and purchasing radio and music subscriptions.

The subject matter disclosed and claimed herein, in one embodiment thereof, comprises a portable device, such as a USB flash drive having pre-loaded music in the form of individual songs, albums, compilations, various performance scores, audio books, and other formats. The flash drive is configured to be used without a Wi-Fi, Bluetooth, satellite, or internet connection for playing music, audio items, or other performances in a vehicle or other passenger compartment. Further, the flash drive enables users to navigate through the pre-loaded music or other performances or recordings via the vehicle's existing audio/music system. The portable device such as a USB flash drive further includes a housing for securely storing a plurality of electronic components, a male USB interface attached to the housing, an art cover for illustrating a pictorial presentation of music stored in the drive or other personalized depiction. The plurality of electronic components includes a flash memory for storing music, a memory controller for controlling read and write operations on the flash memory, a connector for electronically coupling the male USB interface and the memory controller thereby allowing read operation for reading the stored items such as music, performances or other audio content when the male USB interface is connected to a USB port of a vehicle.

In this manner, the USB drive of the present invention with pre-loaded music, performances, compilations, and other audio content accomplishes all of the forgoing objectives and provides users with a portable device such as a USB compatible thumb drive that comes pre-loaded with music albums, compilations, and other audio content. The thumb drive can be used for playing music in a vehicle by inserting the portable device into the USB port of the vehicle or other passenger compartment and without the need to have a Wi-Fi, Bluetooth, satellite or internet connection. The portable drive allows a user to navigate through the stored music, and other audio content via controls disposed on the dashboard or other control area of the vehicle. The drive comes in a variety of shapes and sizes and features album covers, photos, or artwork related to the artist, performances, audio content or other personalized choice on the exterior surface for identification of the drive.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. The sole purpose is to present some general concepts in a simplified form as a prelude to the more detailed description that is presented later.

The subject matter disclosed and claimed herein, in one embodiment thereof, comprises a portable device such as a USB flash drive having pre-loaded music, performances, compilations, and other audio content such as books, theatre music scores and combinations thereof. The USB flash drive further includes a housing for securely storing a plurality of electronic components, the housing may be ergonomically shaped and have finger grabs or areas to assist in the insertion or removal of the device. A USB interface is attached to the housing, an art cover illustrating, for example, a pictorial presentation of music or other items stored in the drive or other personalized depiction. The plurality of electronic components includes a flash memory for storing music or other content, a memory controller for controlling read and write operations on the flash memory, a connector for electronically coupling the USB interface and the memory controller thereby allowing read operation for reading stored music or other content when the USB interface is connected to a USB port of a vehicle.

In yet another embodiment, a portable device such as a USB flash drive having a retractable USB interface is disclosed. The USB flash drive includes a housing having a NAND flash memory chip for storing music, with the flash memory chip having a plurality of blocks and cells serving as memory units. A memory controller for controlling access of the memory blocks and cells; a silicon integrated package for maintaining the flash memory chip and the memory controller. A cavity is provided within the housing for storing a USB interface and the USB interface is coupled to the housing. The housing has a push button positioned thereon for extending or sliding the USB interface from a first position within the cavity to a second position for plugging into a USB port disposed in a dashboard of a vehicle or other area designated for use of such devices. The housing may have an indicator light showing the portable device is in use.

In yet another embodiment, a method for playing music using a vehicle's music system without requiring compact disks, Wi-Fi, Bluetooth, satellite, and internet connections is described. The method includes the steps of providing a portable device such as a USB flash drive with pre-loaded music. The flash drive comprises a flash memory having music and other audio content stored therein, a USB interface for connecting to a USB port, a memory controller for controlling access of stored music or other audio content. Then, the USB interface is inserted into a USB port which is connected to the speakers of the vehicle's music system. A list of songs or other audio content is provided on a display on the dashboard of the vehicle. A list of controls is presented on display for playing, pausing, replaying, shuffling, and moving forward and backward through the displayed list of songs and other audio content.

In yet another embodiment, the method includes the additional steps of providing a portable device, connecting the USB flash drive with a computing system, opening an account, accessing a database for selecting content and deleting at least a portion of stored music or other audio content in flash memory and adding at least one song or other content to the flash memory, selecting an image for the portable device, printing the image on the portable device and receiving a credit for any content returned to the database.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of audio content storage device of the present invention in accordance with the disclosed architecture;

FIG. 2 illustrates a perspective view of the portable device such as a USB drive of FIG. 1 showing internal components in accordance with the disclosed architecture;

FIG. 3A illustrates a perspective view showing how the portable device such as a USB drive of the present invention is inserted into USB port of the vehicle in accordance with the disclosed architecture;

FIG. 3B illustrates a perspective view showing the portable device such as a USB drive of the present invention inserted into USB port of the vehicle in accordance with the disclosed architecture;

FIG. 4 illustrates a flow diagram depicting an exemplary process of formatting the portable device such as a USB drive of the present invention using a conventional computing system in accordance with the disclosed architecture; and

FIG. 5 illustrates a perspective view showing another embodiment of the music storage USB drive of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a simple and non-complicated device that can be safely and effectively used for playing music and other audio content in vehicles. There is also a long-felt need in the art for a music device that does not require Wi-Fi, Bluetooth, satellite, or internet connection for playing music or other audio content. Additionally, there is a long-felt need in the art for a device that can be easily used with any vehicle or passenger compartment for playing music or other audio content. Moreover, there is a long-felt need in the art for a device that does not require a user to connect their smartphone to a radio for listening to music or other audio content in their vehicles. Further, there is a long-felt need in the art for a music or audio content replay device that provides music in a vehicle in cost-effective, convenient, and safe manner. Finally, there is a long-felt need in the art for a music device that can be easily used with all vehicles and other passenger compartments and allows people to play music and other audio content without hassle, compromising safety and purchasing radio, audio content and music subscriptions.

The present invention, in one exemplary embodiment, is a portable device such as a novel USB flash drive having a retractable USB interface. The USB flash drive includes a housing having an NAND flash memory chip for storing music and other audio content, the flash memory chip having a plurality of blocks and cells as memory units; and a memory controller for controlling access of the memory blocks and cells. A silicon integrated package is provided for maintaining the flash memory chip and the memory controller. A cavity is provided within the housing for storing a USB interface and the USB interface is movably coupled to the housing. The housing has a push button positioned thereon for extending the USB interface from a first position within the cavity to a second position for plugging the interface into a USB port disposed in a dashboard or other area of a vehicle or passenger compartment.

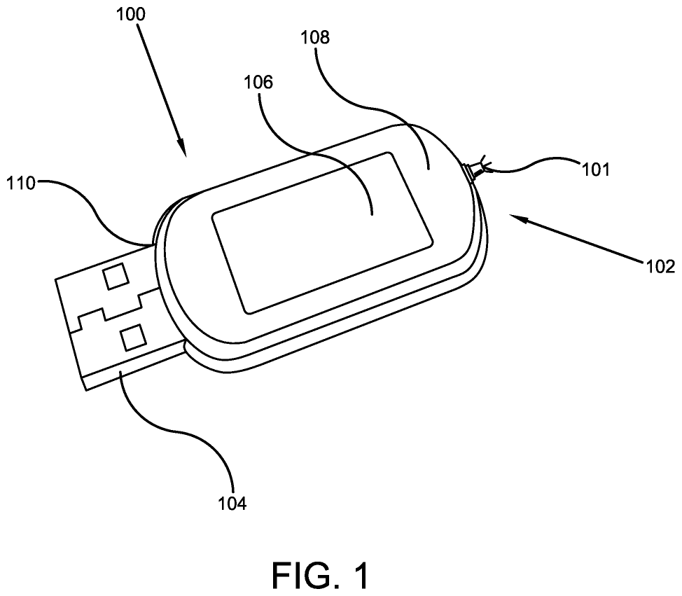

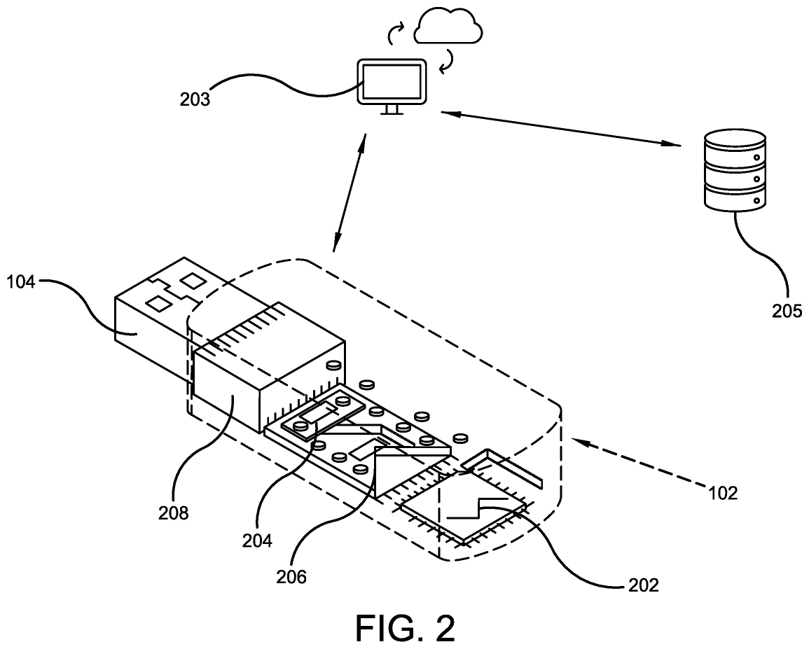

Referring initially to the drawings, FIG. 1 illustrates a perspective view of one potential embodiment of a portable music or audio content storage thumb drive of the present invention in accordance with the disclosed specification. The music or audio content storage thumb drive 100 of the present invention is a formatted device that has pre-stored/pre-loaded music or other audio content and is compatible with USB ports found in vehicles or other passenger compartments. The USB drive 100 is configured to provide music or audio content through the dashboard or other arear and/or speakers of the music player system of the vehicle or passenger compartment without using an internet, satellite, Bluetooth, radio, or other connection. The thumb drive 100 does not require any power and communication signals for providing music or audio content. More specifically, the portable or thumb drive 100 appears like a conventional USB drive and has a housing 102 and a USB interface 104 which is electronically coupled to the housing 102. The housing 102 may be provided with an anti-microbial or anti-viral material so that if the device is shared, the coating will reduce the transfer of germs, bacteria, viruses, pathogens and the like from one user to the next. An illustration such as an art cover 106 of a music album stored in the drive 100 is displayed? on exterior surface 108 of the housing 102. A light 101 is provided on the housing, in the present example at the back end of the housing opposite the interface, to indicate that the device 100 is operating properly. The art cover 106 may be engraved, embossed or removably affixed as per manufacturer requirements and functions as an identification means for a music album stored in the drive 100. The art cover 106 may also be personalized by the user when the USB is being created and a label can be printed by the user to apply over the space for the art cover 106 in the event that there is no option to add the personalization at the time the portable device 100 is manufactured. The USB interface 104 is connected to the housing 102 internally through a connector (shown in FIG. 2) via a slot 110.

The USB drive 100 is especially configured to have audio and visual capabilities allowing the drive 100 to be compatible with a dashboard display and radio controls in the vehicle. The USB drive 100 is based on the Universal Serial Bus mass storage standard and is supported by all operating systems and BIOS. Further, the portable device such as a USB drive 100 is configured to be formatted for adding and deleting music and other audio content by an individual using a computing system 203 (see FIG. 2) such as a laptop. Alternatively, the USB drive 100 can be manufactured by an artist, title, author, production, or music company and cannot be formatted allowing the USB drive 100 to persistently store artist's music album. The USB drive 100 comes in a variety of sizes preferably containing 16, 32, 64, 128, 256, or 512 GB of storage.

The USB drive 100 of the present embodiment may come with a housing 102 having rounded or sharp corners. Further, the housing 102 is made of an opaque material, thereby not allowing internal components of the USB device 100 visible from outside. The USB drive 100 of the present invention has operating temperature in the range from about 0° C. to 50° C.

It should be noted that although the USB interface 104 illustrated in FIG. 1 is USB Type A interface, the thumb drive 100 can have any of the USB interfaces known in the art including but not limited to Type B, Type C, Mini A, Mini B, Micro A, Micro B, and combinations thereof. Further, it is contemplated that future releases of USB interfaces will also be supported by the USB drive 100 of the present invention.

The USB drive 100 is easy to carry and store and when compared with CDs, the USB drive 100 is smaller, faster, has significantly more capacity, and is more durable due to the housing 102 and lack of moving parts. Further, the USB drive 100 is less vulnerable to electromagnetic interference and are unharmed by surface scratches.

FIG. 2 illustrates a perspective view of the USB drive 100 of FIG. 1 showing internal components and external connections in accordance with the disclosed specification. As illustrated, the housing 102 of the drive 100 houses electronic components that allow for functioning of the USB drive 100. More specifically, the drive 100 has a NAND flash memory chip 202 for storing music. The NAND flash memory 202 is a non-volatile storage technology and does not require power to retain data. The flash memory 202 provides quick access to stored data and is configured to be easily formatted for changing music stored in the drive 100. NAND flash memory 202 may include bi-level memory cells or multi-level memory cells. It should be noted that other kinds of flash memory, such as NOR flash memory, may also be used in the USB drive 100 of the present invention.

The drive 100 has a memory controller 204 for controlling read and write operations of the flash memory 202. The memory controller 204 allows the drive 100 to communicate using the USB interface 104 at a low duty-cycle. More specifically, the controller 204 performs wear leveling and evenly distribute reads and writes across blocks of the flash memory 202. The controller 204 can be in the form of a microcontroller with an internal clock system.

The drive 100 has an integrated silicon package 206 that maintains the memory 202 and the controller 204. The silicon package 206 lowers the cost of manufacturing the drive 100 and runs along the housing 102. The integrated silicon package 206 can be in the form of an integrated circuit board.

A connector 208 is positioned at the front end 210 of the housing 102. The connector 208 functions as an interface between the controller 204 and the USB interface 104. The read and write operations in the memory 202 are facilitated by the controller 204 that allows interfacing of the drive 100 with a host device like a vehicle music system. The drive 100 is connected to a computer 203 which is connected to a database 205 for downloading audio content to the device.

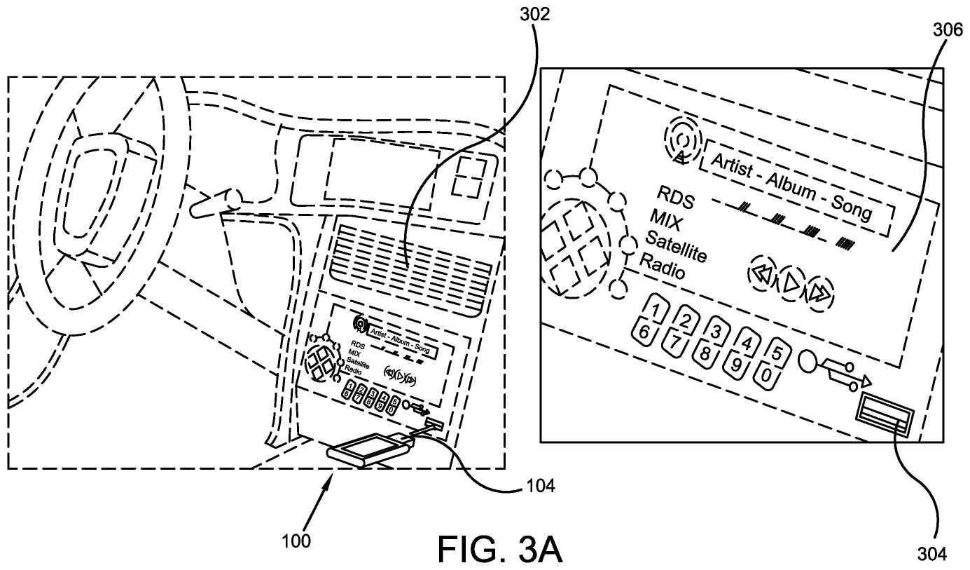

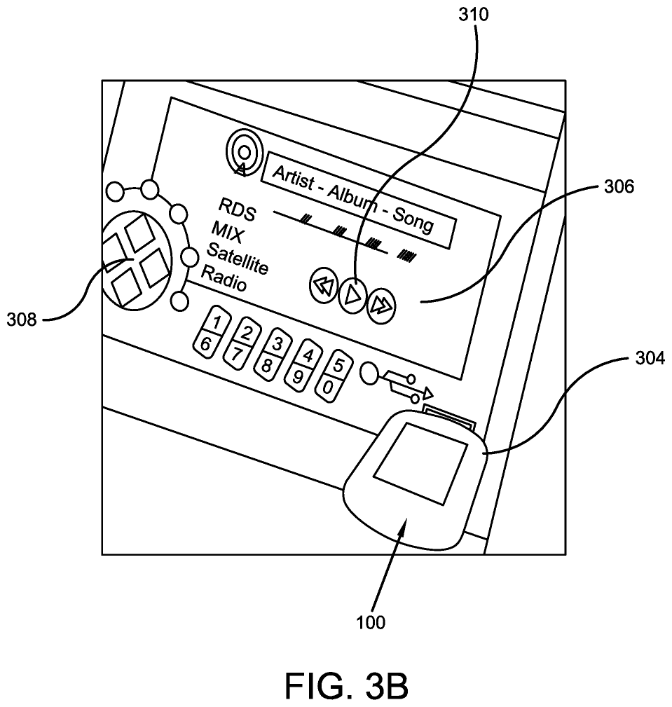

FIG. 3A illustrates a perspective view showing how the USB drive of the present invention is inserted into USB port of the vehicle or passenger compartment in accordance with the disclosed specification. As illustrated, the exemplary dashboard 302 of a vehicle has a USB port 304 for receiving USB interface 104 of the USB drive 100. The USB connector 104 functions as an e connector and is inserted to the USB port 304.

As illustrated, the dashboard display 306 is configured to display a plurality of options excluding the options of USB drive 100 for playing music or other audio content. More specifically, the display 306 displays options pertaining to radio, satellite and others for playing music.

It should be noted that any type of USB port supported by the dashboard or passenger compartment 302 can be used for inserting the USB drive 100 for playing music or other audio content. As stated earlier, the USB connector 104 can be designed to be used with various types of USB ports.

FIG. 3B illustrates a perspective view showing the USB drive of the present invention inserted into a USB port of the vehicle or passenger compartment in accordance with the disclosed specification. As illustrated, the USB connector 104 is received by the USB port 304, thereby allowing the dashboard display 306 to display a plurality of controls for playing music or other audio content stored in the USB drive 100. The control buttons 308 and touch controls 310 are provided on the display 306 allowing a user to easily play, pause, replay, shuffle, and move forward or backward through the list of songs or other content stored in the USB drive 100. It should be appreciated that internet, satellite, Wi-Fi, Bluetooth, radio/streaming subscription, or smartphone connection is not required for playing music or other audio content using the USB drive 100 of the present invention.

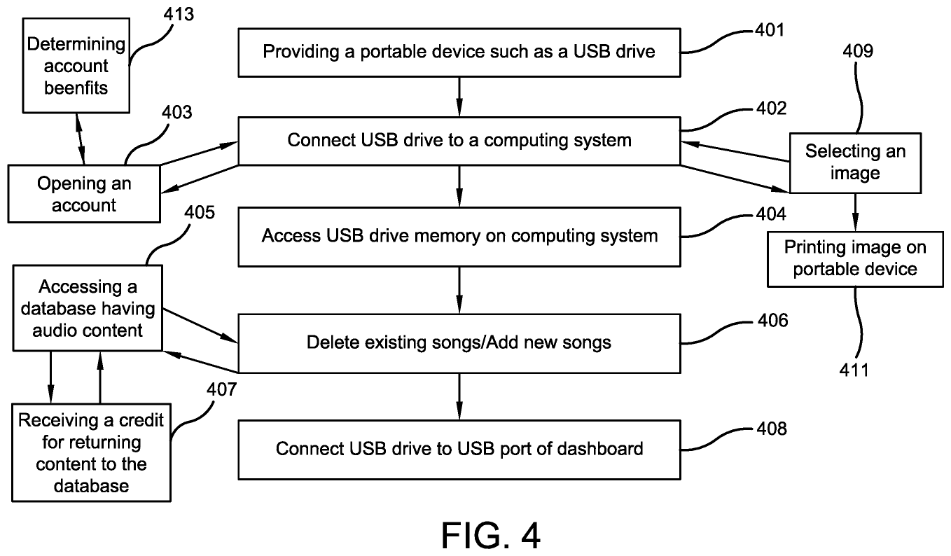

FIG. 4 illustrates a flow diagram depicting an exemplary process of formatting the USB drive of the present invention using a conventional computing system in accordance with the disclosed specification. As illustrated, initially, a portable device such as a USB drive is provided at step 401. The USB drive is connected to a computing system (see FIG. 2) such as a laptop, a conventional computer system or any other storage system having a USB port for receiving the USB drive (Step 402). The individual may need to open an account at step 403 in order to access audio content for the portable device. Then, on display of the computing system, stored content of the USB drive is accessed (Step 404). At step 405, the user accesses a database having audio content and the user may receive a credit at step 407 for returning items to the database, much like returning books to a library and thereby allowing the user to take out additional works. An additional step at 413 may allow the setup of the account and determine the account privileges such as the total number of works an individual may check out at any one time. Thereafter, as per preferences of a user, the songs or other audio content are deleted from flash memory or added to the flash memory resulting in a process of formatting of the drive (Step 406). Finally, the formatted USB drive is connected to USB port of a dashboard of a vehicle for playing the music (Step 408). At step 409 an image is selected for placement on the housing of the portable device and at step 411 the image is printed on the housing or alternatively a label is provided to the user so that the user can apply the label to the housing.

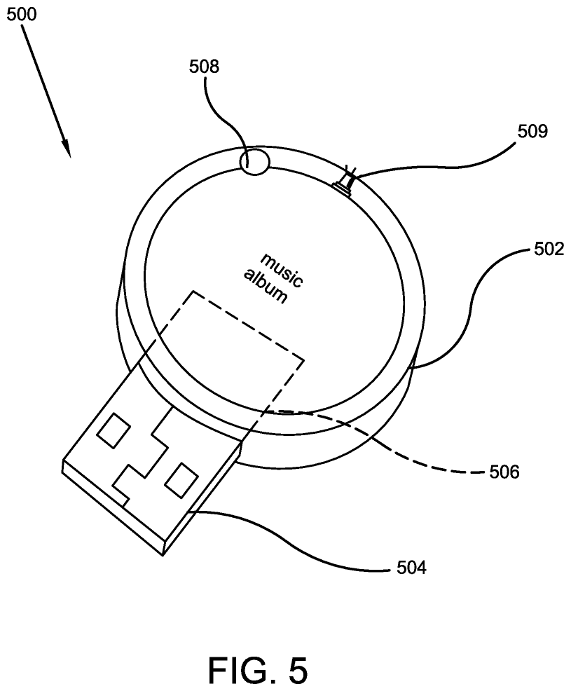

FIG. 5 illustrates a perspective view showing another embodiment of the music or audio storage USB drive of the present invention in accordance with the disclosed specification. In the present embodiment, the USB drive 500 has a circular housing 502 and a USB interface 504. The USB interface 504 in the present embodiment is retractable and can be retracted inside the housing 502 to its first position when the USB drive 500 is not required to be used by the user. The housing 502 has a cavity 506 for storing the USB interface 504 in a retracted position. A push button 508 is positioned on the housing 502 for extending the USB interface 504 from the housing 502 to a second position. The USB interface 504 can be retracted by pushing the USB interface 504 inside the housing 502. A light 509 is provided on the housing to show operational status of the portable device as well as to signal the device is not connected properly. For example, the light 509 may show a first color such as green when the device is operating properly and a second color, such as yellow or red, if the device is not operating properly.

The cavity 506 is dimensioned to store the USB interface 504 without affecting the functionality of the USB drive 500. Further, the electronic components of the drive 500 is same as described in other embodiments of the present invention. The housing 502 has an art cover 510 for aesthetic and identification purposes.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “USB flash drive”, “flash drive”, “drive”, “USB drive”, and “music storage thumb drive” are interchangeable and refer to the USB flash drive with pre-loaded music 100 of the present invention.

Notwithstanding the forgoing, USB flash drive with pre-loaded music 100 of the present invention can be of any suitable size and configuration as is known in the art without affecting the overall concept of the invention, provided that it accomplishes the above-stated objectives. One of ordinary skill in the art will appreciate that the USB flash drive with pre-loaded music 100 as shown in the FIGS. are for illustrative purposes only, and that many other sizes and shapes of the USB flash drive with pre-loaded music 100 are well within the scope of the present disclosure. Although the dimensions of the USB flash drive with pre-loaded music 100 are important design parameters for user convenience, the USB flash drive with pre-loaded music 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A portable audio content device comprising:
a housing having a cavity containing a plurality of electrical components;
a slot disposed in a front end of the housing; and
an interface slidably disposed in the cavity of the housing and movable between a first position and a second position, wherein the plurality of electrical components comprise at least a memory and a memory controller for controlling an operation of the flash memory.

2. The portable audio content device as recited in claim 1, wherein the portable audio content device is a USB drive.

3. The portable audio content device as recited in claim 2, wherein the USB drive is selected from a group consisting of a Type A drive, a Type B drive, a Type C drive, a Mini A drive, a Mini B drive, a Micro A drive and a Micro B drive.

4. The portable audio content device as recited in claim 1, wherein the memory has a storage size selected from a group consisting of a 16 GB, a 32 GB, a 64 GB, a 128 GB, a 256 GB and a 512 GB.

5. The portable audio content device as recited in claim 1, wherein the housing comprises an anti-microbial material or an anti-viral material.

6. The portable audio content device as recited in claim 1, wherein the housing comprises a light disposed on a back end of the housing, opposite the slot.

7. The portable audio content device as recited in claim 6, wherein the light indicates an operational status of the portable audio content device.

8. The portable audio content device as recited in claim 7, wherein the light indicates a first color when the portable audio content device is operating properly and a second color when the portable audio device is not operating properly.

9. The portable audio content device as recited in claim 1, wherein the plurality of electronic components further comprise a silicone package and a connector.

10. The portable audio content device as recited in claim 1, wherein the housing further comprises an external surface having an art cover.

11. The portable audio content device as recited in claim 1, wherein the portable audio content device connects via the interface to a USB port in a passenger compartment of a vehicle.

12. The portable audio content device as recited in claim 1, wherein the controller controls a playing, a pausing, a replaying, a shuffling, a playback speed, and a moving forward and backward of an audio content stored in the memory.

13. The portable audio content device as recited in claim 12, wherein the audio content includes at least one of a song, an album, a compilation, a performance score and an audio book.

14. A USB drive comprising:
a housing having an interface for connecting the USB drive to a USB port and a cavity, wherein the interface is contained within the cavity and is repositionable between a first position and a second position, and further wherein the interface extends outwardly from the housing;
a plurality of electrical components disposed within the cavity and comprising a memory, a controller and a connector;
an audio content stored in the memory and including at least one of a song, an album, a compilation, a performance score and an audio book; and
an art cover positioned on an exterior surface of the housing.

15. The USB drive as recited in claim 14, wherein the exterior surface of the housing comprises at least one of anti-viral material or an anti-microbial material and a light disposed on the exterior surface of the housing opposite a slot for the interface.

16. The USB drive as recited in claim 14, wherein the USB drive has an operating temperature of about 0° C. to 50° C.

17. The USB drive as recited in claim 14, wherein the USB drive has a storage capacity that is selected from a group consisting of a 16 GB, a 32 GB, a 64 GB, a 128 GB, a 256 GB and a 512 GB.

18. A method of using a portable audio content device in a vehicle, the method comprising the steps of:
providing a portable audio content device having a housing;
connecting the portable audio content device to a computing system having a database of audio content;
accessing the database of audio content;
adding at least a portion of the database of audio content to the portable audio content device; and
connecting the portable audio content device to a USB port of a vehicle compartment.

19. The method of using a portable audio content device as recited in claim 18 further comprising a step of creating a user account and a step of determining account privileges for a user after the step of connecting.

20. The method of using a portable audio content device as recited in claim 18 further comprising a step of obtaining an art cover for placement on an exterior surface of the housing.
